(19) United States
(12) Patent Application Publication
(10) Pub. No.: US 2006/0123345 A1
(43) Pub. Date: Jun. 8, 2006

(54) PLATFORM-INDEPENDENT MARKUP LANGUAGE-BASED GUI FORMAT

(75) Inventor: Rakesh K. Parimi, Beacon, NY (US)

Correspondence Address: HOFFMAN, WARNICK & D'ALESSANDRO LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 10/904,934

(22) Filed: Dec. 6, 2004

(51) Int. Cl. G06F 9/00

(52) U.S. Cl. 715/746

(57) ABSTRACT

Methods, systems and program products are disclosed for implementing a platform-independent markup language-based GUI format that includes a plurality of markup language-based platform-independent GUI objects. The platform-independent GUI format allows translation to/from any platform-specific GUI format. GUIs can also be shared between platform-specific GUI formats.

### BACKGROUND OF THE INVENTION

1. Technical Field

The present invention relates generally to graphical user interfaces (GUIs), and more particularly, to a platform-independent markup language-based GUI format.

2. Related Art

A graphical user interface (GUI) is a graphics-based interface that incorporates movable windows, icons and a pointer device, and provides the ability to, for example, resize application windows, change styles and size of fonts. GUIs have become the standard way users interact with a computer and computer-controlled devices. Each computer system and/or application, however, may provide a different platform, which requires a different GUI format to build the GUI.

In multivariate systems that include a variety of computers and/or computer-controlled tools, the variety of different platforms can be large. For example, in a semiconductor manufacturing facility, a number of different lithography tools (MS Windows), etching tools (Linux), and diffusion tools (Unix) may exist. As indicated, each tool may use its own particular platform, and each may use its own set of GUIs. Furthermore, each tool vendor may have its own platform. The above-described factors affect the ability to share GUIs (e.g., GUI components, look-and-feel, etc.) between different tools, and presents a number of challenges for system designers. For example, conventional graphic interface (GI) editors typically require construction of a GUI by an application, and do not allow saving of a GUI. As a result, conversion or migration of a GUI from one platform to another is impossible. That is, each platform typically requires a designer to hard code build each GUI even if the GUI model is produced by another application in the same system. This process can be extremely time consuming. Further, typical GI editors do not allow import/export of a GUI from/into another GUI as a sub-model. Accordingly, useful GUIs cannot be easily shared.

In view of the foregoing, there is a need in the art for a way to reuse a GUI that is platform-independent.

### SUMMARY OF THE INVENTION

The invention includes methods, systems and program products for implementing a platform-independent markup language-based GUI format that includes a plurality of markup language-based platform-independent GUI objects. The platform-independent GUI format allows translation to/from any platform-specific GUI format. GUIs can also be shared between platform-specific GUI formats.

A first aspect of the invention is directed to a method for generating a graphical user interface (GUI) model for use by a first specific platform, the method comprising the steps of: establishing a GUI in a platform-independent GUI format that includes a plurality of markup language-based platform-independent GUI objects; and translating the GUI from the platform-independent GUI format to a GUI format of the first specific platform for generation by the first specific platform.

A second aspect of the invention is directed to a system for generating a graphical user interface (GUI) model for use by a first specific platform, the system comprising: means for establishing a GUI in a platform-independent GUI format that includes a plurality of markup language-based platform-independent GUI objects; and means for translating the GUI from the platform-independent GUI format to a GUI format of the first specific platform for generation by the first specific platform.

A third aspect includes a computer program product comprising a computer useable medium having computer readable program code embodied therein for generating a graphical user interface (GUI) model for use by a first specific platform, the program product comprising: program code configured to establish a GUI in a platform-independent GUI format that includes a plurality of markup language-based platform-independent GUI objects; and program code configured to translate the GUI from the platform-independent GUI format to a GUI format of the first specific platform for generation by the first specific platform.

A fourth aspect includes a graphical interface (GI) generator, comprising: a design system for designing a graphical user interface (GUI) by selecting components therefor from a plurality of platform-independent markup-based objects, each object for instructing construction of a part of a GUI; and a translation map for translating between the platform-independent markup language-based objects and a platform-specific GUI format.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a block diagram of a GUI design environment including a GUI design system according to the invention.

FIG. 2 shows a block diagram of one embodiment of the GUI design system of FIG. 1.

FIG. 3 shows a flow diagram of one embodiment of operational methodology of the GUI design system of FIG. 2.

### DETAILED DESCRIPTION

For purposes of organization only, the description includes the following headings: I. Introduction/Definitions; II. System Overview; III. Operational Methodology; and IV. Conclusion.

### I. INTRODUCTION/DEFINITIONS

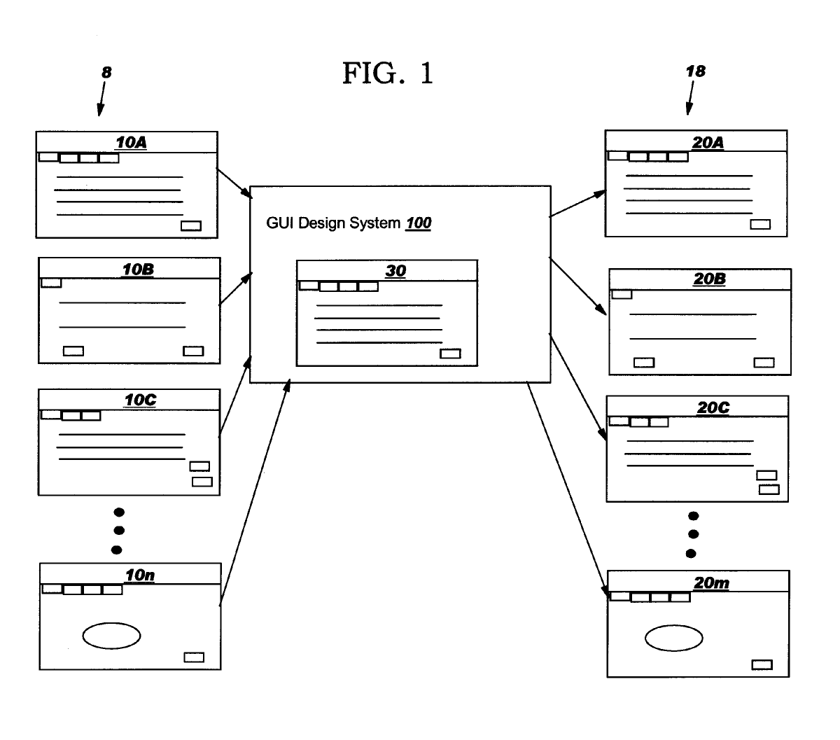

With reference to the accompanying drawings, FIG. 1 illustrates a block diagram illustrating one embodiment of a setting in which the invention may be employed. In this setting, any number of platforms 8, 18 exist, and each platform may implement its own platform-specific GUIs 10A-10n (where n is an integer) and 20A-20m (where m is an integer), respectively. GUIs 10A-10n, each possibly in its own platform 8 specific GUI format, are input to a GUI design system 100 for conversion to at least one other outgoing GUI 20A-20m in a platform 18 specific GUI format. As used herein, “GUI” means any graphical user interface, a model (set) thereof, or component part of the GUI or model thereof. Accordingly, GUI design system 100 is intended to reproduce a particular GUI or model thereof generated in a format for one platform for use on another platform, reproduce a GUI or its model in many different platforms, or selectively reproduce (merge) parts of a GUI or its model in different platforms. A “GUI format” as used herein means an identifiable programming language in which instructions for generating the GUI for a specific platform are written. For example, illustrative platform-specific GUI formats may include: C++, hypertext markup language (HTML), Java, JavaScript, and other proprietary formats. “Platform” means any particular configuration of hardware and/or software such as a hardware platform and the operating system used therewith, a programming environment (e.g., compiler and associated development tools), a networking environment, database environment, transaction processing environment, batch environment or interactive environment, etc.

As will be described below, GUI design system 100 implements a platform-independent markup language-based GUI format that includes a plurality of markup language-based platform-independent GUI objects. GUI design system 100 may also function as a graphical interface generator in which a GUI 30 is designed in the platform-independent GUI format and translated to a platform 18 specific GUI 20A-20m. For purposes of description only, an illustrative basic GUI model may include the following components: Menu, Menu Bar, Menu Separator, Sub Menu and Form. A Menu of that GUI model may have the following attributes: Name, Associated command module, Short-cut command, Highlighted Character in Menu Name, a set of one or more sub menus, and a set of one or more Menu Separators. A Sub Menu of the Menu may have the following attributes: Name, Associated command module, Short-cut command, Highlighted Character in Menu Name, a set of one or more sub menus, and a set of one or more Menu Separators. A Menu Bar of the GUI model may include one or more Menu objects. A Form of the GUI model may consist of one or more (or even none for some attributes) fields such as: Text Fields, Password Fields, Actions (Links, Buttons, etc.), Minimize Button, Maximize Button, Restore Size Button, Other such form/window operations.

A platform-independent markup-language GUI format for implementing the above-described basic GUI model may include the following objects, each including a heading and associated value:

| | Illustrative |
|---|---|
| Heading: | Associated Value: |
| <Menu> | Dropdown Type with |

| | |
|---|---|
| <Name/> | selector button |
| <Command/> | “Patent Print Menu” |
| <Short-cut Command/> | Patentprint.exe |
| <Highlighted Character in Menu | Patprin.exe |

| | |
|---|---|
| Nameb | P |

| | |
|---|---|
| <Sub Menu/>...<Sub Menu/> | Printer Select, |

| | |
|---|---|
| </Menu> | Number copies . . . |
| <Sub Menu> | “Printer Select” |

| | |
|---|---|
| <Name/> | IBMdriver.exe |
| <Command/> | Prindriver.exe |
| <Short-cut Command/> | S |
| <Highlighted Character in Menu | Number copies . . . |

Name/>

<Sub Menu/>... <Sub Menu/>

| </Sub Menu> | |
|---|---|
| <Menu Bar> | File, Edit, View, |

| | |
|---|---|
| <Menu/>... <Menu/> | Insert, Format, Tools . . . |

| <Menu Bar/> | |
|---|---|
| <Form> | Employee #, User |

| | |
|---|---|
| <Text Fields/> | Name . . . |
| <Password Fields/> | ID, password |
| <Actions (Links, Buttons, etc.)/> | Calibrate, Run . . . |
| <Minimize Button/> | Yes |
| <Maximize Button/> | Yes |
| <Restore Size Button/> | No |

</Form>

It should be recognized that while the invention will be described with reference to this particular illustrative basic GUI model, the invention is applicable to any GUI regardless of its makeup. In operation, each object of any platform specific GUI format of interest would be captured in the platform-independent GUI format.

In one embodiment, the platform-independent GUI format may be implemented using an Extensible Markup Language (XML). Alternatively, it may be implemented as a proprietary format, i.e., a Graphical Markup Language. In any event, it is preferable that the platform-independent GUI format be standardized for ease of use.

### II. SYSTEM OVERVIEW

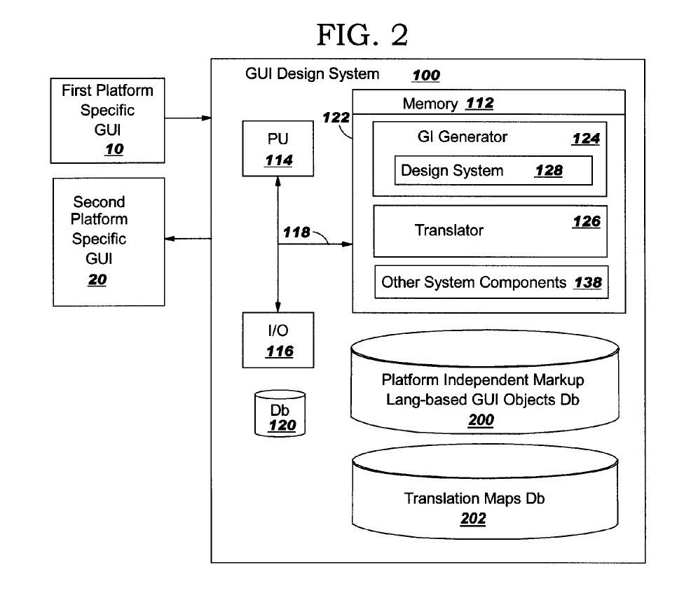

FIG. 2 is a block diagram of a GUI design system 100 in accordance with the invention. System 100 includes a memory 112, a processing unit (PU) 114, input/output devices (I/O) 116 and a bus 118. A database 120 may also be provided for storage of data relative to processing tasks. Memory 112 includes a program product 122 that, when executed by PU 114, comprises various functional capabilities described in further detail below. Memory 112 (and database 120) may comprise any known type of data storage system and/or transmission media, including magnetic media, optical media, random access memory (RAM), read only memory (ROM), a data object, etc. Moreover, memory 112 (and database 120) may reside at a single physical location comprising one or more types of data storage, or be distributed across a plurality of physical systems. PU 114 may likewise comprise a single processing unit, or a plurality of processing units distributed across one or more locations. I/O 116 may comprise any known type of input/output device including a network system, modem, keyboard, mouse, scanner, voice recognition system, CRT, printer, disc drives, etc. Additional components, such as cache memory, communication systems, system software, etc., may also be incorporated into system 100.

As shown in FIG. 2, program product 122 may include a graphical interface (GI) generator 124, a translator 126 and other system components 138. GI generator 124 may include a design system 128. Other system components 138 may include any other necessary functionality not expressly described herein.

It should be recognized that while system 100 has been illustrated as a standalone system, it may be included as part of a larger GUI design system or a peripheral thereto. As shown in FIG. 2, a platform-specific GUI 10 can be input to system 100, and a different platform-specific GUI 20 output from system 100.

Objects of the platform-independent GUI format may be stored in a database 200, as shown in FIG. 2. Similarly, translation maps, which will be described in greater detail below, may be stored in a database 202, as shown in FIG. 2.

### III. OPERATIONAL METHODOLOGY

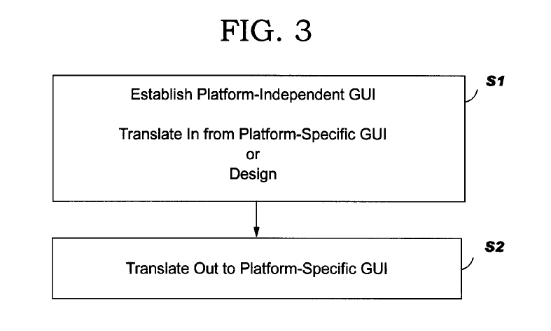

FIG. 3 illustrates a flow diagram of one embodiment of operational methodology of the GUI design system 100 for generating a GUI for use by a first specific platform. The flow diagram will be explained with reference to FIGS. 1-3 together.

In first step S1, a GUI 30 is established in a platform-independent GUI format that includes a plurality of markup language-based platform-independent GUI objects, which may be stored in database 200. The establishing step can be implemented in a variety of ways. First, the establishing step may include GI generator 124 invoking translator 126 to translate a GUI 10A-D from a GUI format for a specific platform 8 into the platform-independent GUI 30. Second, platform-independent GUI 30 may be drafted using a design system 128 of GI generator 124 by a user by selecting from the plurality of markup language-based platform-independent GUI objects and assigning values thereto using GI generator 124. In one embodiment, design system 128 is provided with functionality similar to any now known or later developed GI editors such as what-you-see-is-what-you-get (WYSIWYG) editors, but with the ability to generate the GUI in the platform-independent format. Thirdly, GUI 30 can be established by a combination of the above approaches. For example, a platform 8 specific GUI 10 may be inputted (and translated into the platform-independent GUI format) and features added thereto by GI generator 124.

In step S2, the GUI is translated by translator 124 from the platform-independent GUI format to a GUI 20A-20m in a GUI format of a specific platform 18, which may be user selected, e.g., depending on the system on which the GUI is to be used.

With further regard to translator 124, each translation preferably includes using a translation map for translating between the platform-independent markup language-based objects and a selected one platform-specific GUI format, i.e., the incoming or outgoing format depending on the GUI to be translated. Each translation map includes a conversion set of headings and associated values for each object of the platform-specific GUI format and the platform independent GUI format. For example, for just the Menu field of the above described illustrative basic GUI model, a translation map for, for example, an HTML GUI format may appear as follows:

| Platform-Independent Heading | | Associated Value | HTML Heading | HTML Value |
|---|---|---|---|---|
| <Menu> | | DD Type with | <Menu Typo | Drop/Sel |
| | | selector button | | |
| | <Name/> | “Patent Print Menu” | <Designation/> | “Patent Print |
| | <Command/> | Patentprintexe | <Executable> | Menu” |
| | <Short-cut | Patprin.exe | <Shortcut> | Patprint.exe |

| | | | |
|---|---|---|---|
| Command/> | P | <Highlight> | Patprint.exe |

| | |
|---|---|
| <Highlighted | P |

| | | |
|---|---|---|
| Character in Menu | Printer Select . . . | <Sub>...<Sub> |

| | |
|---|---|
| Name/> | Printer Selection |

| | |
|---|---|
| <Sub Menu/>...<Sub | <Menu Type> |

Menu/>
</Menu>

The invention also includes graphical interface (GI) generator 124 including a platform-independent graphical user interface (GUI) format (stored in db 200) including a plurality of platform-independent markup-based objects (as shown in table above), and a translation map (shown immediately above) for translating between the platform-independent markup language-based objects and a platform-specific GUI format.

The invention may also include a method for converting a GUI from one platform to another platform including: translating each object for constructing a GUI from a first platform-specific GUI format to a platform-independent GUI format including a plurality of platform-independent markup language-based objects; and translating each object from the platform-independent GUI format to a second platform-specific GUI format.

It should be recognized that in addition to the above-described illustrative applications of the invention, the invention can be applied to any graphical modeling. In particular, the invention enables capture of any graphical model in a markup language-based platform-independent GUI format and helps easily extract required model features. For example, a new GUI being developed may require certain menu functions already implemented in another GUI. In such cases, the new GUI being developed will extract relevant parts from the stored markup language representation of the earlier developed model. In another example, two or more platform-specific GUIs may have been developed, and one of those GUIs is to be used as the basic framework for another GUI. The invention provides for a markup language-based representation of the original GUI for easy model representations and extractions. In another example, a merger of two or more existing GUIs may be desired. The platform-independent markup language-based GUI format allows representation of each GUI and merger of relevant sections of the models.

### IV. CONCLUSION

In the previous discussion, it will be understood that the method steps discussed are performed by a processor, such as PU 114 of system 100, executing instructions of program product 122 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A method for generating a graphical user interface (GUI) model for use by a first specific platform, the method comprising the steps of:
establishing a GUI in a platform-independent GUI format that includes a plurality of markup language-based platform-independent GUI objects; and
translating the GUI from the platform-independent GUI format to a GUI format of the first specific platform for generation by the first specific platform.

2. The method of claim 1, wherein the establishing step includes drafting the GUI in the platform-independent GUI format by selecting from the plurality of markup language-based platform-independent GUI objects.

3. The method of claim 1, wherein the establishing step includes translating the GUI from a GUI format for at least one second specific platform into the platform-independent GUI format.

4. The method of claim 3, wherein each translating step includes using a translation map for translating between the platform-independent markup language-based objects and a selected one platform-specific GUI format.

5. The method of claim 3, wherein the establishing step includes merging at least two GUIs, where each GUI is in a different platform-specific GUI format, into a single GUI in the platform-independent GUI format.

6. The method of claim 1, wherein the translating step includes using a translation map for translating between the platform-independent markup language-based objects and a GUI format of the first specific platform.

7. The method of claim 6, wherein the translation map includes a conversion set of headings and associated values for each object of the platform-specific GUI format and the platform independent GUI format.

8. The method of claim 1, wherein each object includes a heading and an associated value.

9. The method of claim 1, wherein the platform-specific GUI format is selected from the group consisting of: C++, hypertext markup language (HTML), Java and JavaScript.

10. The method of claim 1, wherein the GUI format for the first specific platform is user selected.

11. A system for generating a graphical user interface (GUI) model for use by a first specific platform, the system comprising:
means for establishing a GUI in a platform-independent GUI format that includes a plurality of markup language-based platform-independent GUI objects; and
means for translating the GUI from the platform-independent GUI format to a GUI format of the first specific platform for generation by the first specific platform.

12. The system of claim 11, wherein the establishing means includes means for drafting the GUI in the platform-independent GUI format by selecting from the plurality of markup language-based platform-independent GUI objects.

13. The system of claim 11, wherein the establishing means includes means for translating the GUI from a GUI format for a second specific platform into the platform-independent GUI format.

14. The system of claim 13, wherein each translating means includes means for using a translation map for translating between the platform-independent markup language-based objects and a selected one platform-specific GUI format.

15. The system of claim 11, wherein the translating means includes means for using a translation map for translating between the platform-independent markup language-based objects and a GUI format of the first specific platform.

16. The system of claim 15, wherein the translation map includes a conversion set of headings and associated values for each object of the platform-specific GUI format and the platform independent GUI format.

17. The system of claim 11, wherein each object includes a heading and an associated value.

18. The system of claim 11, wherein the platform-specific GUI format is selected from the group consisting of: C++, hypertext markup language (HTML), Java, and JavaScript.

19. A computer program product comprising a computer useable medium having computer readable program code embodied therein for generating a graphical user interface (GUI) model for use by a first specific platform, the program product comprising:
program code configured to establish a GUI in a platform-independent GUI format that includes a plurality of markup language-based platform-independent GUI objects; and
program code configured to translate the GUI from the platform-independent GUI format to a GUI format of the first specific platform for generation by the first specific platform.

20. The program product of claim 19, wherein the establishing code includes program code configured to draft the GUI in the platform-independent GUI format by selecting from the plurality of markup language-based platform-independent GUI objects.

21. The program product of claim 19, wherein the establishing code includes program code configured to translate from a GUI format for a second specific platform into the platform-independent GUI format.

22. The program product of claim 21, wherein the translating code includes program code configured to use a translation map for translating between the platform-independent markup language-based objects and a selected one GUI format of the first and second specific platforms.

23. The program product of claim 19, wherein the translating code includes program code configured to use a translation map for translating between the platform-independent markup language-based objects and a GUI format of the first specific platform.

24. The program product of claim 23, wherein the translation map includes a conversion set of headings and associated values for each object of the platform-specific GUI format and the platform independent GUI format.

25. The program product of claim 19, wherein each object includes a heading and an associated value.

26. A graphical interface (GI) generator, comprising:
a design system for designing a graphical user interface (GUI) by selecting components therefor from a plurality of platform-independent markup-based objects, each object for instructing construction of a part of a GUI; and
a translation map for translating between the platform-independent markup language-based objects and a platform-specific GUI format.

27. The GI generator of claim 26, wherein each object includes a heading and an associated value.

28. The GI generator of claim 26, wherein the translation map includes a conversion set of headings and associated values for each object of the platform-specific GUI format and the platform-independent GUI format.

29. The GI generator of claim 26, wherein the platform-specific GUI format is selected from the group consisting of: C++, hypertext markup language (HTML), Java, and JavaScript.

30. The GI generator of claim 26, wherein the platform-specific GUI format is user selected.
